(19) United States
(12) Patent Application Publication
(10) Pub. No.: US 2011/0114908 A1
(43) Pub. Date: May 19, 2011

(54) WEAR AND CORROSION RESISTANT COATING HAVING A ROUGHENED SURFACE

(76) Inventors: Richard N. Fargo, Plainville, CT (US); Kathryn Rauss Sherrick, Bristol, CT (US); David Wayne Mckee, Somers, CT (US); Jon George Demos, West Hartford, CT (US)

(21) Appl. No.: 12/997,283

(22) PCT Filed: Jul. 3, 2008
(86) PCT No.: PCT/US08/69129

§ 371 Date: Dec. 10, 2010

(51) Int. Cl. B66D 3/04; B05D 3/12

(52) U.S. Cl. 254/390; 427/277

(57) ABSTRACT

An exemplary method of making a first component for contacting another component includes applying a wear and corrosion resistant material layer onto a surface of the first component. The wear and corrosion resistant material layer is then roughened subsequent to having been applied to the surface. A component comprises an exemplary elevator sheave that includes a metallic body having a sheave surface that is adapted to contact an elevator tension member. A corrosion resistant material layer on the sheave surface has a thickness that is greater than about 5 microns.

### BACKGROUND

Elevator systems carry passengers, cargo or both between different levels in a building, for example. Some elevator systems operate on a hydraulic machine arrangement to move the elevator car as desired. Other elevator systems are traction-based and rely upon traction between a traction sheave and an elevator roping arrangement to cause desired movement of the elevator car.

Typical traction-based elevator systems include a roping arrangement that has a plurality of tension members such as steel ropes or flat belts, for example. The roping arrangement follows a path defined by sheaves placed strategically within the elevator system. At least one of the sheaves operates as a traction sheave causing the roping arrangement to move responsive to operation of a machine that causes the traction sheave to rotate. Other sheaves are considered idler sheaves that move responsive to movement of the roping arrangement. Controlling the direction and speed of movement of the traction sheave provides the ability to move the elevator car in a desired direction at a desired speed.

It is necessary to have sufficient traction between the traction sheave and the tension members to achieve desired elevator car movement and to control car position, for example. Where round steel rope tension members are used, specially shaped grooves or plastic liners within grooves are used for traction purposes. In systems using flat belts as the tension members, the conventional approach to having a sufficient traction surface on a traction sheave involves sandblasting a steel surface to roughen it. A roughened surface provides more traction than a smoother surface, for example.

It is also necessary to avoid corrosion of an elevator sheave. In round rope systems, lubricant is applied to the ropes. The lubricant provides some corrosion protection. The conventional approach to avoid corrosion in belted systems has been to plate the roughened surface of the sheave with a corrosion resistant material such as hard chrome. The plating protects the surface of the sheave from wear and corrosion.

One shortcoming of the conventional approach is that plating over the roughened surface of the sheave tends to change surface characteristics such as reducing the roughness. This is especially true if the plating has any appreciable thickness. Typically, plating is kept to a maximum thickness of two microns to minimize altering the desired roughness of the sheave surface. One drawback associated with such a thin plating layer is that it is likely to crack or have voids. Leaving the metal of the sheave surface exposed along such cracks or voids leaves the surface susceptible to corrosion, for example. Additionally, any wear of the very thin layer leaves exposed metal.

There are other uses of metal components that require a corrosion and wear resistant coating outside of elevator systems.

It would be desirable to provide better wear and corrosion protection while still being able to achieve the necessary surface characteristics for a given situation.

### SUMMARY

An exemplary method of making a first component for contacting another component includes applying a wear and corrosion resistant material layer onto a surface of the first component. The corrosion resistant material layer is then roughened subsequent to having been applied to the surface.

An exemplary component includes a metallic body having a surface that is adapted to contact another component. A corrosion resistant material layer on the surface has a thickness that is greater than about 5 microns.

The various features and advantages of the disclosed examples will become apparent to those skilled in the art from the following detailed description. The drawings that accompany the detailed description can be briefly described as follows.

### BRIEF DESCRIPTION OF THE DRAWINGS

FIG. 1 schematically illustrates selected portions of an example elevator system.

FIG. 2 diagrammatically illustrates an example elevator sheave.

FIG. 3 schematically illustrates an example method of applying a corrosion resistant coating to an elevator sheave.

### DETAILED DESCRIPTION

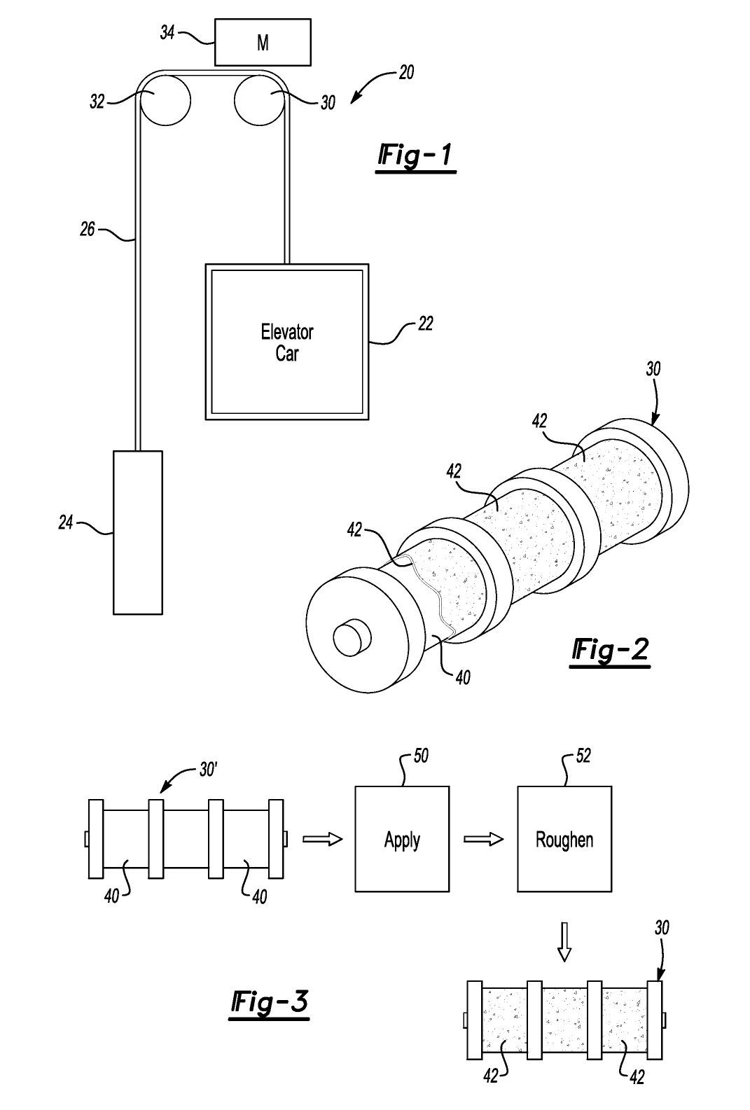

For discussion purposes an elevator system and an elevator component that requires wear and corrosion protection are used as an example implementation. FIG. 1 shows selected portions of an elevator system 20. An elevator car 22 and counterweight 24 are suspended by a roping arrangement 26 of tension members. The one-to-one roping arrangement 26 is shown for discussion purposes only. In many examples, the elevator system 20 the roping arrangement has a two-to-one roping ratio. In one example, the tension members include a plurality of round ropes. In another example, the tension members include a plurality of flat belts.

A traction sheave 30 and an idler sheave 32 establish a path along which the roping arrangement 26 travels for purposes of moving the elevator car 22 as desired. An elevator machine 34 causes the necessary movement of the traction sheave 30 to achieve the desired elevator car movement. In certain exemplary applications, the traction sheave 30 could be a surface of the machine shaft rather than a separate component.

The traction sheave 30 has a roughened surface to achieve the necessary traction between the tension members of the roping arrangement 26 and an appropriate surface on the traction sheave 30. The traction sheave 30 also has a corrosion resistant material on the surfaces that are adapted to contact the tension members of the roping arrangement 26.

FIG. 2 shows one example traction sheave 30. This example includes a metallic body 40. One example comprises low carbon steel as the material used for forming the metallic body of the traction sheave 30. In this example, the metal body of the traction sheave 30 includes an exterior surface that is smooth. The surfaces of the metallic body 40 that contact the tension members are coated with a corrosion resistant material layer 42. As schematically shown in FIG. 2, the corrosion resistant material layer 42 is partially cutaway leaving a part of the sheave body surface 40 exposed only for discussion purposes. The metal of the body 40 is not exposed on a finished example sheave. The corrosion resistant material layers 42 are roughened to achieve a desired traction between the roping arrangement 26 and the traction sheave 30.

FIG. 3 schematically illustrates an example method of making a traction sheave such as the traction sheave 30 in the example of FIG. 2. A metallic traction sheave body 30′ is formed having the desired traction sheave configuration. In one example, the traction sheave surfaces of the metallic body 40 are smooth at the initial stage of the procedure shown in FIG. 3. At 50, a corrosion resistant material is applied to the surfaces 40. In one example, applying the corrosion resistant material includes hot dipping the sheave body into an appropriate material. Another example includes applying the corrosion resistant material by plating the sheave surfaces 40. Another example includes flame spraying the corrosion resistant material onto the surfaces 40. Another example includes plasma spraying the corrosion resistant material onto the sheave body. Given this description and the particular materials selected by one skilled in the art, an appropriate one of these example application techniques can be used.

One example corrosion resistant material comprises electroless nickel. Another example comprises electroless nickel and between 5% and 10% phosphorous. Electronic nickel is another example material. Other example corrosion resistant materials include hard chromes such as a hard nodular chrome or a trivalent metallic chrome. Such materials are selected for their hardness, wear resistance and corrosion resistance properties.

In FIG. 3, after the corrosion resistant material is applied to the sheave surfaces 40, the corrosion resistant material layer is roughened at 52. One example includes using a blasting technique for roughening the surface of the corrosion resistant material. Providing a roughened surface provides the necessary traction between the traction sheave 30 and the roping arrangement 26. One example includes using an alumina blasting media and controlling the blasting parameters to achieve a desired roughness on the surface without introducing any cracking in the corrosion resistant material layer 42.

Prior to this invention it was believed that blasting after applying a corrosion resistant material would cause cracking. Therefore, the conventional technique involved applying a very thin layer (e.g., two microns thick) of a corrosion resistant material onto a previously roughened surface. Such a thin layer was required to maintain the desired roughness of the surface. Such a thin layer, however, prevented any subsequent treatment because it would result in cracking the plating on the surface. The example technique differs substantially from previous techniques in that the corrosion resistant material layer is roughened after it is applied to the surface.

With the disclosed example technique, it is possible to apply a thicker layer of corrosion resistant material. A thicker layer provides longer-lasting wear and corrosion resistance and allows for subsequently treating that layer to achieve the desired roughness. One example includes a thickness of at least 5 microns for the corrosion resistant material layer 42. Another example includes a thickness up to 60 microns. One particular example has a thickness between 15 and 30 microns. Such thicknesses are useful for providing corrosion protection, wear resistance and the ability to roughen the surface of the layer 42 without causing it to crack or otherwise be damaged in an undesirable manner. Depending on the selected thickness of the corrosion resistant material layer 42 and the particular blasting media, the particulars of the blasting technique can be tuned to achieve a desired roughness while avoiding cracking the applied material layer 42. Given this description, those skilled in the art will be able to achieve a desired roughness for their particular application that meets their particular needs.

As shown in FIG. 3, the resulting traction sheave 30 has sheave surfaces adapted to contact load bearing members of the roping arrangement 26 that are coated with a corrosion resistant material layer 42 that is sufficiently roughened to achieve the desired traction characteristics.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

1. A method of making an elevator sheave for contacting an elevator load bearing member, comprising the steps of:
applying a wear and corrosion resistant material layer onto a surface of the elevator sheave; and
roughening the wear and corrosion resistant material layer subsequent to the applying.

2. The method of claim 1, comprising
roughening the corrosion resistant material layer by blasting the wear and corrosion resistant material layer.

3. The method of claim 2, comprising
using an alumina blasting media having a grit selected to avoid cracking of the wear and corrosion resistant material layer during the blasting.

4. The method of claim 1, wherein the applying step comprises hot dipping the surface in the wear and corrosion resistant material.

5. The method of claim 1, wherein the applying step comprises plating the wear and corrosion resistant material onto the surface.

6. The method of claim 1, wherein the applying step comprises flame spraying the wear and corrosion resistant material onto the surface.

7. The method of claim 1, wherein the applying step comprises plasma spraying the wear and corrosion resistant material onto the surface.

8. The method of claim 7, wherein the wear and corrosion resistant material is at least one of a trivalent metallic chrome or a hard nodular chrome.

9. The method of claim 1, wherein the wear and corrosion resistant material comprises electrolytic nickel.

10. The method of claim 1, wherein the wear and corrosion resistant material comprises electroless nickel.

11. The method of claim 10, wherein the wear and corrosion resistant material comprises between about 5% and about 10% phosphorous.

12. The method of claim 1, comprising
applying the wear and corrosion resistant material layer to provide a thickness of the corrosion resistant material between about 5 and about 60 microns.

13. The method of claim 12, comprising providing a thickness of between about 15 micros and about 30 microns.

14. (canceled)

15. A elevator sheave, comprising
a metallic body having a sheave surface adapted to contact an elevator load bearing member; and
a wear and corrosion resistant material layer on the sheave surface, the corrosion resistant material having a thickness greater than about 25 microns.

16. The elevator sheave of claim 15, wherein the metallic body sheave surface has a first roughness and the wear and corrosion resistant material layer has an exterior surface having a second, rougher roughness.

17. The elevator sheave of claim 15, wherein the thickness is less than about 60 microns.

18. The elevator sheave of claim 15, wherein the thickness is between about 25 microns and about 30 microns.

19. The elevator sheave of claim 15, wherein the wear and corrosion resistant material is at least one of a trivalent metallic chrome or a hard nodular chrome.

20. The elevator sheave of claim 15, wherein the corrosion resistant material comprises electrolytic nickel.

21. The elevator sheave of claim 15, wherein the wear and corrosion resistant material comprises electroless nickel.

22. The elevator sheave of claim 21, wherein the wear and corrosion resistant material comprises between about 5% and about 10% phosphorous.
